(19) United States
(12) Patent Application Publication
(10) Pub. No.: US 2009/0061722 A1
(43) Pub. Date: Mar. 5, 2009

(54) MANUFACTURING METHOD FOR DISPLAY DEVICE

(75) Inventors: Masataka Natori, Chiba (JP); Osamu Nagashima, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/198,140

(22) Filed: Aug. 26, 2008

(30) Foreign Application Priority Data
Aug. 27, 2007 (JP) 2007-219159

(51) Int. Cl. H01J 9/26

(52) U.S. Cl. 445/25

(57) ABSTRACT

(Object) To provide a manufacturing method for a display device according to which a hole is created in a pair of substrates using a water jet without causing damage.

(Means for Achieving Object) A manufacturing method for a display device according to which a closed annular sealing material is formed between a first substrate and a second substrate which are provided so as to face each other and a through hole is created by cutting out part of the above described first substrate and the above described second substrate in a region surrounded by the sealing material, characterized in that
part of the above described first substrate and the above described second substrate are cut out by moving a water jet relative to the above described first substrate and the above described second substrate starting from an initial point where the above described first substrate and the above described second substrate are penetrated, and
a gap burying member is formed between the above described first substrate and the above described second substrate in advance at the above described initial point.

The present application claims priority from Japanese application JP2007-219159 filed on Aug. 27, 2007, the content of which is hereby incorporated by reference into this application.

### BACKGROUND OF THE INVENTION

(1) Field of the Invention

The present invention relates to a manufacturing method for a display device and to, for example, a manufacturing method for a liquid crystal display device used for amusement.

(2) Related Art Statement

Liquid crystal display devices having a through hole created in the center portion in the display region, for example, are known as liquid crystal displays for amusement.

These liquid crystal display devices allow an image in the display region to be viewed with the eye, and at the same time, a member provided on the rear surface to be viewed directly through the above described through hole, and thus can be used to form game machines which are interesting to the player.

That is to say, liquid crystal display devices are formed so that a pair of substrates made of glass, for example, which are placed so as to face each other through liquid crystal are used as external walls, and the region surrounded by a sealing material formed by sealing the above described liquid crystal between the respective substrates is used as a display region.

In the case where a through hole is created in the center portion of the display region within a region surrounded by the above described sealing material (referred to as first sealing material), a sealing material different from the first sealing material (referred to as second sealing material) is provided in a closed annular pattern, so that a display region can be formed by sealing liquid crystal into the region surrounded by the first sealing material and the second sealing material.

Thus, a hole is created in each substrate in the above described pair in the region surrounded by the second sealing material, in which no liquid crystal is sealed, and thus, the above described through hole is created.

The configuration of this liquid crystal display device is disclosed in, for example, the following Patent Document 1.

(Patent Document 1) Japanese Unexamined Patent Publication 2004-329692

### SUMMARY OF THE INVENTION

### (Problem to Be Solved by the Invention)

Attempts have been made to use a water jet which penetrates through the two substrates and move the water jet relative to the above described pair of substrates in order to create a through hole by cutting the pair of substrates when creating a hole in the pair of substrates in the region surrounded by the sealing material during the manufacture of the above described liquid crystal display device.

A water jet was used because it allows a through hole to be created in the pair of substrates rapidly and with high precision.

There is a disadvantage, however, in that at least one of the substrates may be broken by the water jet at the stage where the initial hole (starting point) that penetrates through the pair of substrates is created.

The cause for this was found to be that at the moment when the water jet penetrates through the first substrate, water enters the gap between the two substrates (surrounded by the second sealing material) and doesn't have a place to escape, and as a result, at least one of the substrates is damaged. The present invention is provided on the basis of this knowledge.

An object of the present invention is to provide a manufacturing method for a display device according to which a hole is created in a pair of substrates using a water jet without causing damage.

### (Means for Solving Problem)

The gist of typical inventions from among those disclosed in the present specification is briefly described below.

(1) The manufacturing method for a display device according to the present invention is a manufacturing method for a display device according to which a closed annular sealing material is formed between a first substrate and a second substrate which are provided so as to face each other and a through hole is created by cutting out part of the above described first substrate and the above described second substrate in a region surrounded by the sealing material, and characterized in that

part of the above described first substrate and the above described second substrate are cut out by moving a water jet relative to the above described first substrate and the above described second substrate starting from an initial point where the above described first substrate and the above described second substrate are penetrated, and

a gap burying member is formed between the above described first substrate and the above described second substrate in advance at the above described initial point.

(2) The manufacturing method for a display device according to the present invention has the same steps as (1), and is characterized in that the diameter of the above described gap burying member is greater than the diameter of the above described water jet, for example.

(3) The manufacturing method for a display device according to the present invention has the same steps as (1) or (2), and is characterized in that the above described water jet penetrates through the above described gap burying member when the above described water jet penetrates through the above described first substrate and the above described second substrate at the above described initial point, for example.

(4) The manufacturing method for a display device according to the present invention has the same steps as any of (1) to (3), and is characterized in that the above described gap burying member is made of the same material as the above described sealing material, for example.

(5) The manufacturing method for a display device according to the present invention has the same steps as any of (1) to (4), and is characterized in that the location of the above described initial point and the location of the water jet at the point in time when cutting out of part of the above described first substrate and the above described second substrate using the above described water jet is completed are different in a plane, for example.

(6) The manufacturing method for a display device according to the present invention has the same steps as any of (1) to (5), and is characterized in that the above described water jet passes through a region where the gap burying member is not formed during the movement relative to the above described first substrate and the above described second substrate, for example.

(7) The manufacturing method for a display device according to the present invention has the same steps as any of (1) to (6), and is characterized in that the display device is a liquid crystal display device and the region surrounded by the above described sealing material is a non-display region provided in a portion within the display region, for example.

Here, the present invention is not limited to the above described methods, and various modifications are possible within such a range as not to deviate from the technical idea of the present invention.

### Effects of the Invention

According to the manufacturing method for a display device created as described above, a hole can be created in a pair of substrates using a water jet without causing damage.

### BRIEF DESCRIPTION OF THE DRAWINGS

FIGS. 1(a) to 1(e) are diagrams illustrating a process for creating a hole in a pair of substrates using a water jet in the manufacturing method for a display device according to one embodiment of the present invention;

FIGS. 2(a) and 2(b) are diagrams showing the configuration of a display device to which the manufacturing method for a display device according to one embodiment of the present invention is applied;

FIGS. 3(a) to 3(b′) are diagrams illustrating the movement of the water jet when a through hole is created in the display device shown in FIG. 2;

FIGS. 4(a) to 4(e) are diagrams illustrating the disadvantage when a hole is created in a pair of substrates in the case where no gap burying member is formed; and

FIGS. 5(a) and 5(b) are diagrams showing the hole that penetrates through the gap burying member and the hole which is subsequently created by moving the water jet.

### EXPLANATION OF NUMERALS

SUB1, SUB2 . . . substrates
CH (V) . . . semiconductor device (scanning signal drive circuit)
CH (H) . . . semiconductor device (video signal drive circuit)
SL1 . . . first sealing material
SL2 . . . second sealing material
OPN . . . through hole
GL . . . gate signal lines
DL . . . drain signal lines
CL . . . common signal lines
TFT . . . thin film transistors
PX . . . pixel electrodes
CT . . . facing electrodes
GB . . . gap burying member
WJ . . . water jet
PH, PH′ . . . holes

### DETAILED DESCRIPTION OF THE INVENTION

### (Best Mode for Carrying Out the Invention)

In the following, the manufacturing method for a display device according to the embodiments of the present invention is described in reference to the drawings.

### One Embodiment of Object to which Invention is Applied

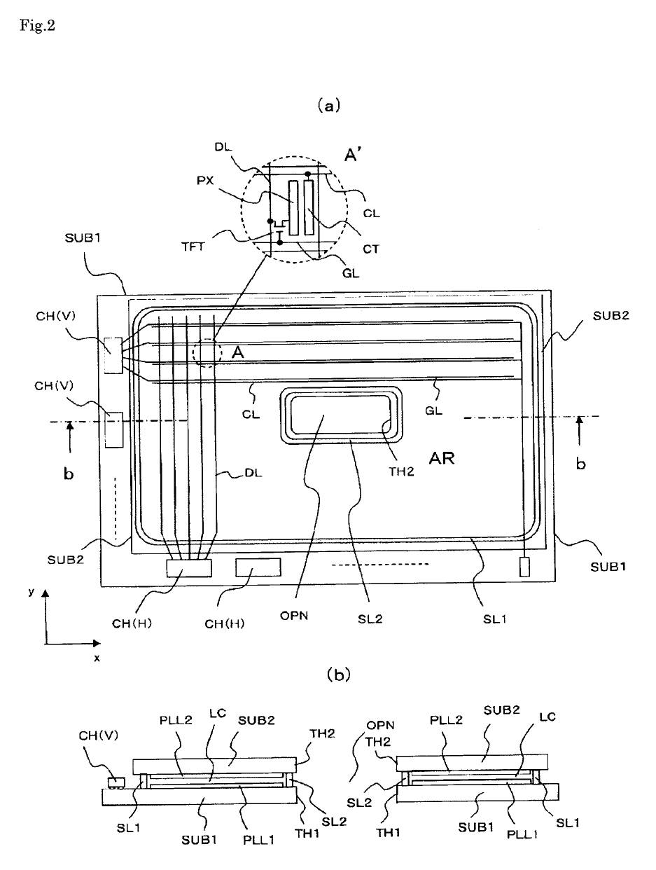

First, prior to the description of the manufacturing method for a display device according to the present invention, one embodiment of a display device which is an object to which the invention is applied is described in reference to FIG. 2.

FIG. 2(a) is a plan diagram, and FIG. 2(b) is a cross sectional diagram along line b-b in FIG. 2(a).

The display device is a liquid crystal display device, and the external walls are a substrate SUB1 (substrate on bottom in figure) and substrate SUB2 (substrate on top in figure) made of glass, for example, which are provided so as to face each other through liquid crystal LC.

The substrate SUB1 is slightly larger than the substrate SUB2, and thus, the above described substrate SUB1 is provided in such a state that the surface having a relatively large area in the left side portion and in the lower side portion in the figure is exposed from the above described substrate SUB2. As a result, the below described semiconductor device CH (V) which is a scanning signal drive circuit and semiconductor device CH (H) which is a video signal drive circuit, for example, are mounted on the surface of the above described left side portion and lower side portion, respectively.

The substrate SUB2 is secured to the above described substrate SUB1 by means of a sealing material SL provided between the substrate SUB1 and the substrate SUB2, and this sealing material SL also functions to seal in the above described liquid crystal LC. As a result, the region where the liquid crystal LC is sealed in by the sealing material SL forms a display region AR.

In the case of this embodiment, the above described sealing material SL is provided with a first sealing material (referred to as SL1 in the figure) formed along the periphery of the substrate SUB1 so as to be closed in annular form, and a second sealing material (referred to as SL2 in the figure) formed within the region surrounded by the first sealing material SL1 so as to be closed in annular form, and the region surrounded by the first sealing material SL1 and the second sealing material SL2 is formed as the above described display region AR.

The above described substrate SUB1 and substrate SUB2 have holes TH1 and TH2, respectively, which are created by cutting out the center of the substrate in the region surrounded by the above described second sealing material SL2, and a through hole OPN of which the side wall is formed of the respective cut surfaces of the above described substrates SUB1 and SUB2 and the inner periphery portion of the above described second sealing material SL2 is created within the above described display region AR in the configuration.

In the case where the liquid crystal display device is used as an apparatus for amusement, for example a slot machine, the through hole OPN is used in such a manner that a number of rotating drums are aligned and installed on the rear surface of the liquid crystal display device so that part of the side of the rotating drums protrudes toward the player through the through hole OPN in approximately the center of the display region AR. In addition, various modes of use are possible for the above described through hole OPN, in addition to the above described usage.

Here, the substrate SUB1 and the substrate SUB2 are pasted together by means of the above described first sealing material SL1 and second sealing material SL2, and after that, part of the substrate SUB2 and the substrate SUB1 in the region surrounded by the above described second sealing material SL2 is cut out using a water jet, so that the above described through hole OPN is created. This method is described in detail below.

A great number of pixels are formed in the display region AR, which is the region surrounded by the above described first sealing material SL1 and second sealing material SL2 and aligned in a matrix.

Each of these pixels is formed in a rectangular region (pixel region) surrounded by gate signal lines GL which extend in the x direction and are aligned in the y direction in the figure, and drain signal lines DL which extend in the y direction and are aligned in the x direction within the above described display region AR on the surface of the substrate SUB1 on the liquid crystal side.

In addition, as shown in FIG. 2A′ showing an enlargement of part of the display region AR within the dotted circle A, a thin film transistor TFT which is turned on by a signal (scanning signal) from a gate signal line GL and a pixel electrode PX to which a signal (video signal) is supplied from a drain signal line DL via this thin film transistor TFT that is turned on are formed in the pixel region.

The pixel electrode PX allows an electrical field for orienting the molecules in the liquid crystal LC to be generated between the pixel electrode PX and the facing electrode CT, and a signal having a potential which becomes a reference for the potential of the above described video signal (reference voltage signal) is supplied to the facing electrode CT via the common signal line CL, which is parallel to the gate signal line GL, for example.

One end of the above described gate signal line GL, for example that on the left side, passes over the first sealing material SL1 and extends over the surface of the substrate SUB1 so as to be connected to the output terminal of the semiconductor device CH (V), which is the above described scanning signal drive circuit. This semiconductor device CH (V) supplies a scanning signal to the above described gate signal lines GL from the gate signal line GL in the upper stage to the gate signal line GL in the lower stage in sequence, and then repeats this.

One end of the above described drain signal line DL, for example that on the bottom, passes over the first sealing material SL1 and extends over the surface of the substrate SUB1 so as to be connected to the output terminal of the semiconductor device CH (H), which is the above described video signal drive circuit. This semiconductor device CH (H) supplies a video signal to the above described drain signal lines DL in accordance with the timing with which the above described scanning signals are supplied.

Here, the above described gate signal lines GL, drain signal lines DL, thin film transistors TFT, pixel electrodes TX and facing electrodes CT formed on the surface of the substrate SUB1 on the liquid crystal side are formed of a patterned multilayer body of a conductive layer, an insulating layer and a semiconductor layer, and this multilayer body is shown as multilayer body PLL1 in FIG. 2(b).

In addition, a black matrix (light blocking film) dividing the respective elements and color filters which cover the respective pixel regions are formed and layered on the surface of the substrate SUB1 on the liquid crystal side, and this multilayer body is shown as multilayer body PLL2 in FIG. 2(b).

### <Creation of Through Hole OPN Using Water Jet>

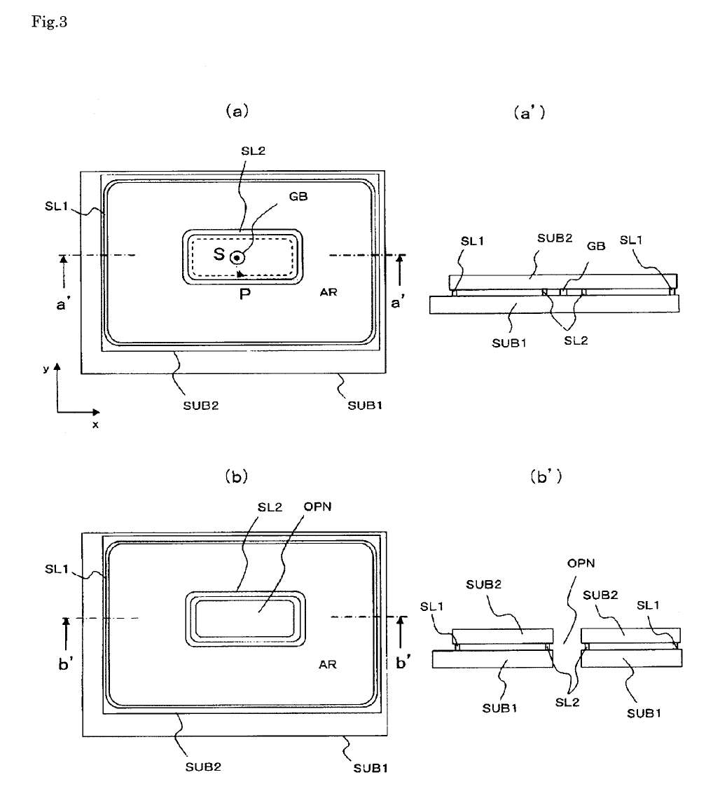

FIG. 3 is a diagram illustrating the method for creating a through hole OPN in the display region AR by cutting out part of the substrate SUB2 and the substrate SUB1 in a region surrounded by the above described second sealing material SL2 using a water jet according to one embodiment.

The through hole OPN is created after pasting the substrate SUB1 and the substrate SUB2 together by means of the above described first sealing material SL1 and second sealing material SL2. Therefore, though in reality the multilayer body PLL1 shown in FIG. 2(b) is formed on the surface of the above described substrate SUB1 on the liquid crystal side and the multilayer body PLL2 shown in FIG. 2(b) is formed on the surface of the above described substrate SUB2 on the liquid crystal side, these multilayer bodies PLL1 and PLL2 are omitted in FIG. 3 for the sake of simplicity.

In addition, FIG. 3 shows the area surrounded by the second sealing material slightly larger than in the case of FIG. 2. This is for the sake of making the illustration easier to understand.

Here, at this stage, it is not necessary for liquid crystal CL to be sealed in the region between the first sealing material SL1 and the second sealing material SL2. This is because liquid crystal LC does not particularly relate to the implementation of the present invention.

FIG. 3(a) is a plan diagram showing a case where the substrate SUB1 and the substrate SUB2 are pasted together by means of the above described first sealing material SL1 and second sealing material SL2. FIG. 3(a′) is a cross sectional diagram along line a′-a′ in FIG. 3(a).

In this case, a member for filling the gap between the substrate SUB1 and the substrate SUB2 (hereinafter referred to as gap filling member GB) is formed in a portion within the region surrounded by the second sealing material SL2 in advance.

The above described gap filling member GB may be formed by applying the same material as the first sealing material SL1 and the second sealing material SL2 to the substrate SUB1 or the substrate SUB2 when the first sealing material SL1 and the second sealing material SL2 is provided, for example. In addition, a material which is different from the above described fist sealing material SL1 and second sealing material SL2 may be provided in a different step from the step of providing the above described first sealing material SL1 and second sealing material SL2. The gap filling member GB may be formed at the same time as the spacer in columnar form in the step of forming a spacer in columnar form, for example.

The portion where this gap filling member GB is formed is the initial point from which the water jet moves (substrates SUB1 and SUB2 may move) in the case where part of the substrate SUB2 and the substrate SUB1 is cut out in a shape corresponding to the movement.

In this case, the diameter of the above described gap filing member GB is greater than the diameter of the above described water jet, and the location of the above described initial point for the water jet is set so that the center axis of the water jet approximately coincides with the center axis of the above described gap filling member GB.

Here, the water jet is used in such a state as to have a flow-out energy from the front surface of the substrate SUB2 to the rear surface of the substrate SUB1. This is because part of the substrate SUUB2 and the substrate SUB1 is cut out using the water jet.

As shown in FIG. 3(a), the portion where the gap filling member GB is formed is the initial point (shown by S in figure), and the water jet is moved from this initial point S in the −y direction in the figure, for example, and the movement in this direction is continued until the water jet reaches the point P in the figure, which is in the vicinity of the second sealing material SL2.

After that, the water jet moves along the inside of the above described second sealing material SL2 and back to the above described point P while keeping the location in the vicinity of the inside of the second sealing material SL2 (this movement is shown by the dotted line in the figure).

At this stage, a shape corresponding to the movement of the water jet is cut out from the substrate SUB2 and the substrate SUB1 in the region surrounded by the second sealing material SL2. FIGS. 3(b) and 3(b′) are figures showing how a through hole OPN is created inside the display region AR by cutting out part of the substrate SUB2 and the substrate SUB1.

<Relationship between Water Jet and Gap Filling Member GB at Initial Point>

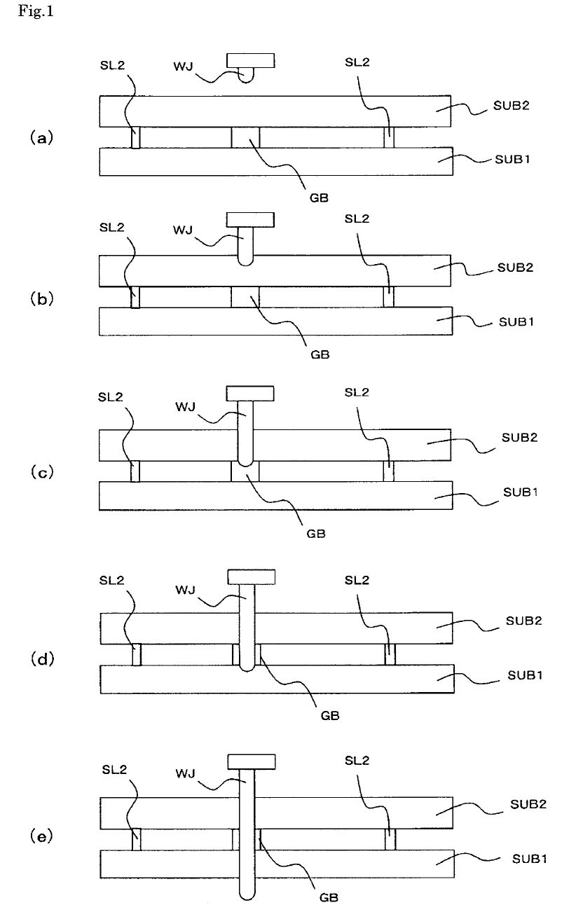

FIGS. 1(a) to 1(e) are diagrams chronologically illustrating a process in which the flow-out energy of the water jet WJ which is jetted from the nozzle is increased at the above described initial point S and the water jet reaches the rear surface of the substrate SUB1 from the front surface of the substrate SUB2.

FIG. 1(a) is a diagram showing the state when the water jet WJ starts being jetted from the nozzle, FIG. 1(b) is a diagram showing the state when the front end of the water jet WJ starts penetrating the surface of the substrate SUB2, FIG. 1(c) is a diagram showing the state when the front end of the water jet WJ has penetrated through the substrate SUB2 and starts penetrating the gap filling member GB, FIG. 1(d) is a diagram showing the state when the front end of the water jet WJ has penetrated through the gap filling member GB and starts penetrating the surface of the substrate SUB1, and FIG. 1(e) is a diagram showing the state when the front end of the water jet WJ has penetrated through the substrate SUB1.

As can be seen here, in the process there is no chance of the water jet WJ entering the space between the substrate SUB1 and the substrate SUB2 and between the second sealing material SL2 and the gap filling member GB, and the water jet WJ only penetrates through the substrate SUB2, the gap filing member GB and the substrate SUB1 in sequence.

As described above, this is because the location of the water jet WJ at the initial point is set so that the center axis of the water jet WJ approximately coincides with the center axis of the above described gap filling member GB and the diameter of the water jet WJ is smaller than the diameter of the gap filling member GB.

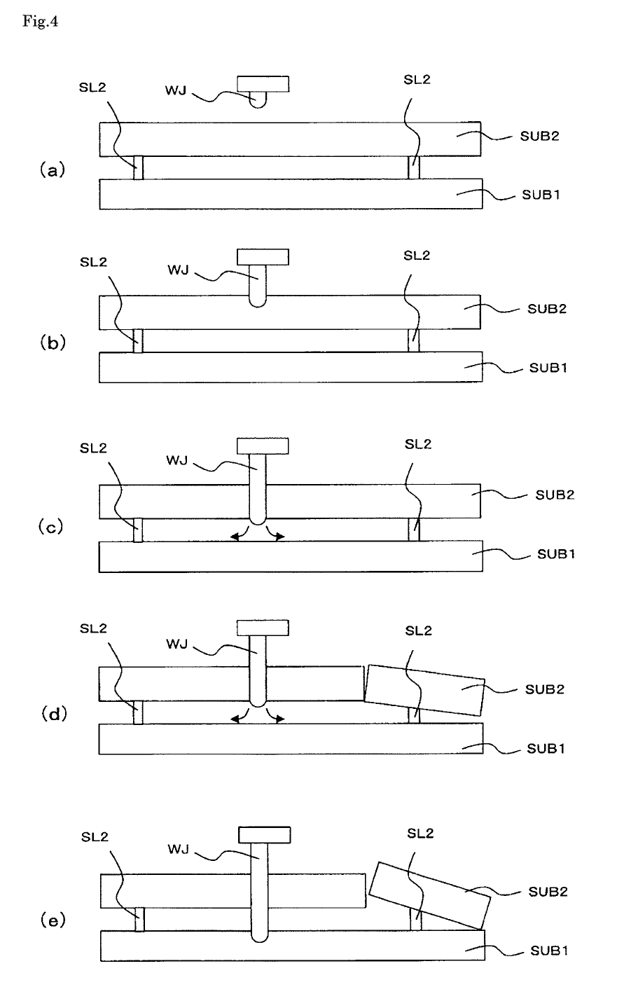

Incidentally, FIGS. 4(a) to 4(e) are diagrams illustrating the disadvantage in the case where the above described gap filling member GB is not provided, and correspond to the above described FIGS. 1(a) to 1(e).

As shown in FIG. 4(c), after the water jet WJ starts penetrating the substrate SUB2, the front end reaches the space surrounded by the second sealing material SL2 between the substrate SUB1 and the substrate SUB2 and the space is filled with water. Then, as shown in FIG. 4(d), the water pressure increases in the space, and eventually the substrate SUB2 cracks, for example. Furthermore, as shown in FIG. 4(e), when the water jet WJ starts penetrating through the substrate SUB1, the water pressure further increases in the above described space, and the substrate SUB2 breaks.

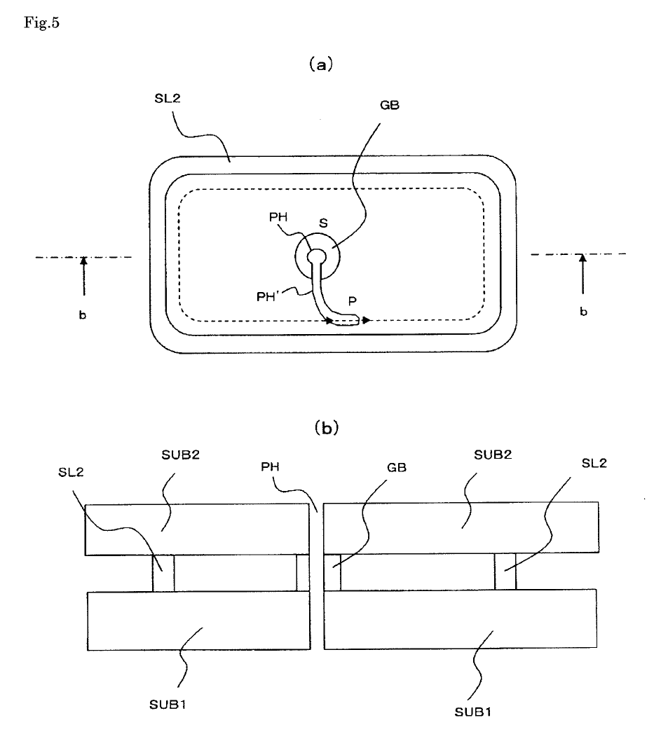

Here, FIGS. 5(a) and 5(b) are diagrams showing a case where the above described water jet WJ is moved from the location where the above described gap filling member GB is provided to a portion in the vicinity of the second sealing material SL2 after the step in the above FIG. 1(e) (point P), and FIG. 5(a) is a plan diagram and FIG. 5(b) is a cross sectional diagram along line b-b in FIG. 5(a).

When the water jet WJ moves to the above described point P, a hole PH′ is created along the movement and is connected to the hole PH created in the above described space filling member GB (also created in substrates SUB1 and SUB2 having the same center) using the water jet WJ (not shown).

In this case, the water jet WJ passes through the above descried hole PH′, and therefore, no water from the water jet WJ enters the space surrounded by the second sealing material SL2 between the substrate SUB1 and SUB2, and accordingly, there is no worry of the substrates SUB1 and SUB2 cracking or being damaged.

After that, as shown in FIG. 3, the water jet WJ is moved along the inner side of the above described second sealing material SL2 while keeping the location in the vicinity of the inside of the second sealing material SL2 and back to the above described point P (this movement is shown by a dotted line in the figure), so that part of the substrate SUB2 and the substrate SUB1 is cut out and the above described through hole OPN is created.

Here, though a liquid crystal display device according to the present invention is described, the present invention can be applied to display devices other than liquid crystal display devices.

1. A manufacturing method for a display device according to which a closed annular sealing material is formed between a first substrate and a second substrate which are provided so as to face each other and a through hole is created by cutting out part of said first substrate and said second substrate in a region surrounded by the sealing material, characterized in that
part of said first substrate and said second substrate are cut out by moving a water jet relative to said first substrate and said second substrate starting from an initial point where said first substrate and said second substrate are penetrated, and
a gap burying member is formed between said first substrate and said second substrate in advance at said initial point.

2. The manufacturing method for a display device according to claim 1, characterized in that the diameter of said gap burying member is greater than the diameter of said water jet.

3. The manufacturing method for a display device according to claim 2, characterized in that said water jet penetrates through said gap burying member when said water jet penetrates through said first substrate and said second substrate at said initial point.

4. The manufacturing method for a display device according to any of claim 1, characterized in that said gap burying member is made of the same material as said sealing material.

5. The manufacturing method for a display device according to any of claim 1, characterized in that the location of said initial point and the location of the water jet at the point in time when cutting out of part of said first substrate and said second substrate using said water jet is completed are different in a plane.

6. The manufacturing method for a display device according to any of claim 1, characterized in that said water jet passes through a region where the gap burying member is not formed during the movement relative to said first substrate and said second substrate.

7. The manufacturing method for a display device according to any of claim 1, characterized in that the display device is a liquid crystal display device and the region surrounded by said sealing material is a non-display region provided in a portion within the display region.
